(19) United States
(12) Patent Application Publication
(10) Pub. No.: US 2019/0204020 A1
(43) Pub. Date: Jul. 4, 2019

(54) MANUFACTURING METHOD OF HEAT DISSIPATION DEVICE

(71) Applicant: ASIA VITAL COMPONENTS (CHINA) CO., LTD., Shenzhen (CN)

(72) Inventors: Han-Min Liu, Shenzhen (CN); Xiao-Xiang Zhou, Shenzhen (CN)

(21) Appl. No.: 15/860,668

(22) Filed: Jan. 3, 2018

(51) Int. Cl. F28D 15/04; F28D 15/02; B23K 26/00

(52) U.S. Cl. CPC F28D 15/046; B23K 26/0084; F28D 15/0283

(57) ABSTRACT

A manufacturing method of a heat dissipation device is disclosed. The heat dissipation device includes a main body and a tubular body. The main body has a chamber contained with a working fluid. A capillary structure is formed on an inner surface of the chamber by means of laser processing. One face of the main body is a condensation face, while the other face of the main body is a heat absorption face. The capillary structure is disposed corresponding to the heat absorption face. The heat absorption face of the main body is made of titanium material. The condensation face is made of titanium material or metal material. The tubular body is correspondingly inserted in the main body. The capillary structure is formed by means of laser processing. This not only solves the problem that the titanium material is difficult to process, but also can enhance the production efficiency.

### BACKGROUND OF THE INVENTION

### 1. Field of the Invention

The present invention relates generally to a manufacturing method of a heat dissipation device. In the manufacturing method of the heat dissipation device, a capillary structure is formed on titanium material by means of laser processing.

### 2. Description of the Related Art

A vapor chamber is an often seen heat dissipation device applied in heat dissipation field. The vapor chamber is often made of copper, aluminum, stainless steel or the like. In manufacturing, such material is easy to cause potential difference, which will lead to corrosion. In addition, in case the conventional vapor chamber made of copper, aluminum or stainless steel is applied to a large-scale industrial apparatus, the vapor chamber often has a large volume and very heavy weight for achieving sufficient strength. In case the vapor chamber is applied to a handheld device such as an intelligent mobile phone or a tablet, the vapor chamber needs to be extremely thinned. Under such circumstance, the thickness of the vapor chamber will be too thin to have sufficient strength. Therefore, in recent years, some manufacturers have in advance employed titanium material to manufacture the heat dissipation device applied in the heat dissipation field.

Titanium is a lightweight metal material having high structural strength and anticorrosion property. Therefore, titanium has been widely used in various fields. Titanium has many advantages. However, titanium has high structural strength so that it is hard to process titanium.

Titanium cannot be processed in the conventional processing manner. Titanium necessitates a special or nontraditional processing method to process. As a result, titanium cannot be applied to all situations. Some manufacturers employ discharging method or wet etching method to process titanium and remove a part of the material. However, the processing speed of the discharging method is too slow to apply to a mass-production situation that needs to remove a great amount of material. With respect to wet etching method, it is hard to control the depth of the channels formed by the processing. In addition, the solvent and gas used in the processing are toxic and apt to cause contamination of environment. Moreover, it is quite hard to reduce the oxide produced from titanium in a high-temperature environment.

It is therefore tried by the applicant to provide a heat dissipation device and a manufacturing method thereof, in which titanium is employed as the material of the vapor chamber and is easy to process to form the capillary structure so as to solve the above problems existing in the conventional vapor chamber.

### SUMMARY OF THE INVENTION

It is therefore a primary object of the present invention to provide a manufacturing method of a heat dissipation device. The heat dissipation device is made of titanium material. A capillary structure is formed on the titanium material by means of laser processing.

To achieve the above and other objects, the heat dissipation device of the present invention includes a main body and a tubular body.

The main body has a chamber. A capillary structure is formed on an inner surface of the chamber by means of laser processing. A working fluid is contained in the chamber. One face of the main body is a condensation face, while the other face of the main body is a heat absorption face. The capillary structure is disposed corresponding to the heat absorption face. The heat absorption face of the main body is made of titanium material. The condensation face is made of titanium material or metal material. The tubular body is correspondingly inserted in the main body.

Still to achieve the above and other objects, the manufacturing method of the heat dissipation device of the present invention includes steps of:

S1. providing an upper plate and a lower plate and a tubular body;

S2. forming a capillary structure on one face of the lower plate by means of laser processing;

S3. mating the upper and lower plates with each other and correspondingly disposing the tubular body between the upper and lower plates and sealing a periphery of the upper and lower plates together with the tubular body to form a chamber; and

S4. vacuuming the chamber and filling water into the chamber from the tubular body and finally sealing the tubular body.

In the manufacturing method of the heat dissipation device of the present invention, the vapor chamber is made of titanium material instead of copper or aluminum so that the lifetime of the vapor chamber is prolonged. Moreover, the titanium material can be processed by laser to form the capillary structure. This solves the problem of the conventional vapor chamber that the titanium material is difficult to process.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the heat dissipation device of the present invention;

FIG. 2 is a sectional assembled view of the first embodiment of the heat dissipation device of the present invention; and

FIG. 3 is a flow chart of a first embodiment of the manufacturing method of the heat dissipation device of the present invention.

### DETAILED DESCRIPTION OF THE PREFERRED EMBODIMENTS

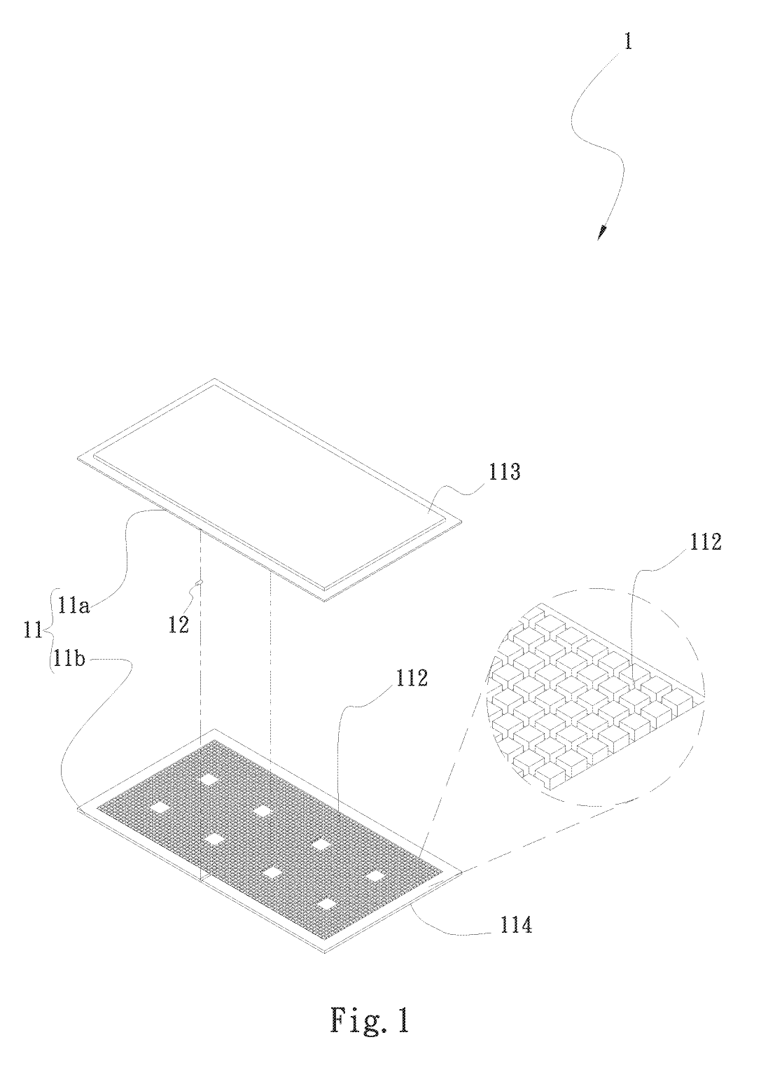

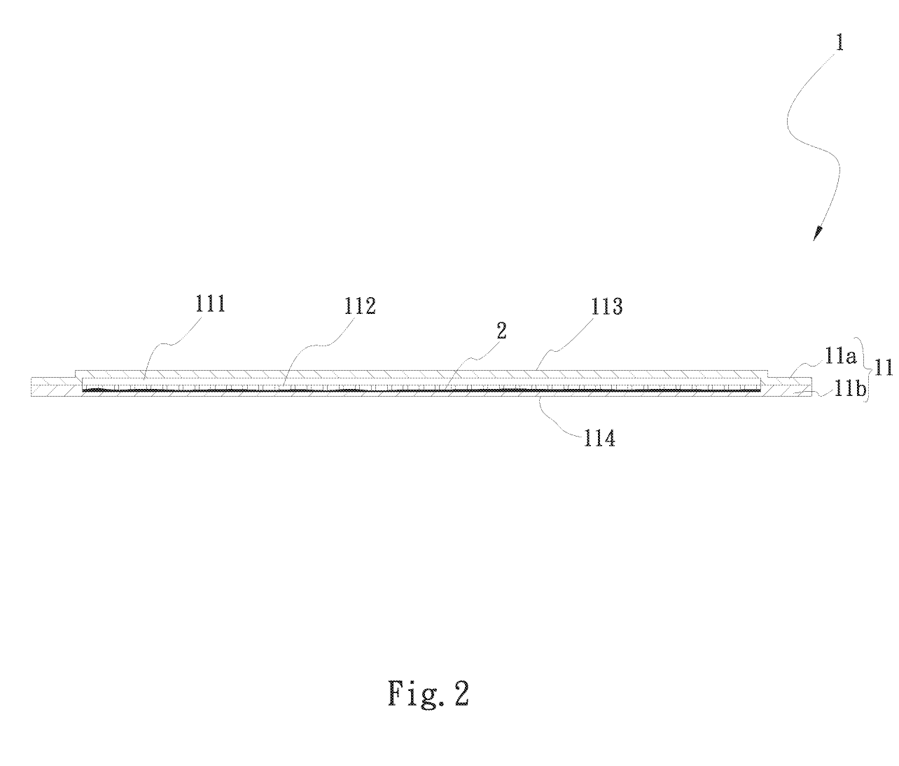

Please refer to FIGS. 1 and 2. FIG. 1 is a perspective exploded view of a first embodiment of the heat dissipation device of the present invention. FIG. 2 is a sectional assembled view of the first embodiment of the heat dissipation device of the present invention. According to the first embodiment, the heat dissipation device 1 of the present invention includes a main body 11 and a tubular body 12.

The main body 11 has a chamber 111. A capillary structure 112 is formed on an inner surface of the chamber 111 by means of laser processing. A working fluid 2 is contained in the chamber 111. One face of the main body 11 is a condensation face 113, while the other face of the main body 11 is a heat absorption face 114. The capillary structure 112 is disposed corresponding to the heat absorption face 114. The heat absorption face 114 of the main body 11 is made of titanium material. The titanium material is commercial pure titanium or titanium alloy. The condensation face 113 is made of titanium material, metal material or ceramic material. The metal material is selected from a group consisting of gold, silver, copper, aluminum and stainless steel. The tubular body 12 is correspondingly inserted in the main body 11 in communication with the internal chamber 111 of the main body 11.

The main body 11 has an upper plate 11a and a lower plate 11. The condensation face 113 is positioned on one face of the upper plate 11a, while the heat absorption face 114 is positioned on one face of the lower plate 11b. The upper and lower plate bodies 11a, 11b are mated with each other to define the chamber 111 together with the tubular body 12. The capillary structure 112 is disposed on the other face of the lower plate 11b opposite to the heat absorption face 114. The capillary structure 112 is, but not limited to, a micro-channeled structure or a structure composed of multiple raised bodies or recesses arranged at intervals. In this embodiment, the capillary structure 112 is a micro-channeled structure for illustration purposes. The tubular body 12 is disposed between the upper and lower plate bodies 11a, 11b. After the upper and lower plate bodies 11a, 11b are overlapped and mated with each other, the periphery is sealed. At the same time, the tubular body 12 is connected with the upper and lower plate bodies 11a, 11b to keep the main body 11 airtight.

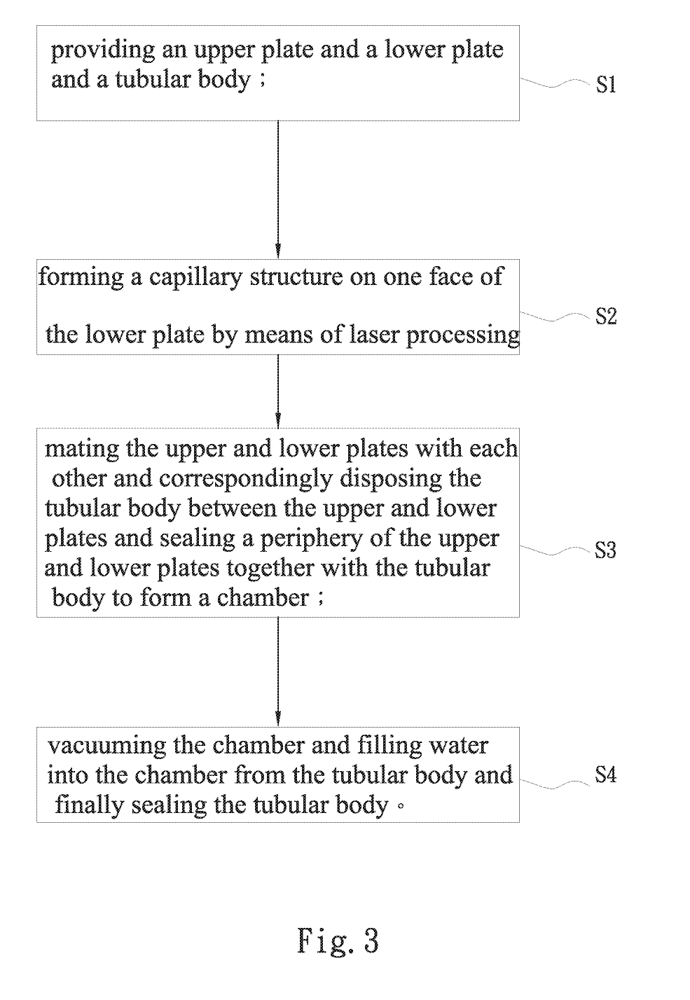

Please refer to FIG. 3, which is a flow chart of a first embodiment of the manufacturing method of the heat dissipation device of the present invention. The manufacturing method of the heat dissipation device of the present invention includes steps of:

S1. providing an upper plate and a lower plate and a tubular body, at least two plate bodies being provided as the substrates for manufacturing the heat dissipation device 1, in this embodiment, the heat dissipation device 1 being, but not limited to, a vapor chamber for illustration purposes, the two plate bodies being an upper plate 11a and a lower plate 11b of the vapor chamber, the upper and lower plates 11a, 11b being made of the same material or different materials, in this embodiment, the upper and lower plates 11a, 11b being, but not limited to, made of different materials for illustration purposes, the material of the upper plate 11 a being metal or ceramic material, the metal material being selected from a group consisting of gold, silver, copper, aluminum, stainless steel and titanium, in this embodiment, the lower plate 11b being., but not limited to, made of titanium material for illustration purposes, the titanium material being commercial pure titanium or titanium alloy;

S2. forming a capillary structure on one face of the lower plate by means of laser processing, the material of one face of the lower plate 11b being partially removed by means of laser processing, the capillary structure 112 being composed of multiple micro-channels, the micro-channels being simply longitudinal channels, simple transverse channels or both longitudinal and transverse channels intersecting each other, in this embodiment, the micro-channels being, but not limited to, both longitudinal and transverse channels intersecting each other;

S3. mating the upper and lower plates with each other and correspondingly disposing the tubular body between the upper and lower plates and sealing a periphery of the upper and lower plates together with the tubular body to form a chamber, the upper plate 11a and the lower plate 11b that has been laser-processed being overlapped and mated with each other, at the same time, the tubular body 12 being disposed between the upper and lower plate bodies 11a, 11b and the periphery of the upper and lower plates 11a, 11b being sealed, whereby the upper and lower plates 11a, 11b and the tubular body 12 together define a chamber 111 to complete the main body 11 of the vapor chamber; and

S4. vacuuming the vapor chamber and filling water into the vapor chamber from the tubular body and finally sealing the tubular body, the main body 11 of the vapor chamber being vacuumed and filled with water through the tubular body 12, after the vacuuming and water-filling processes are completed, an open end of the tubular body 12 being sealed to complete the manufacturing process.

In the heat dissipation device of the present invention and the manufacturing method thereof, the capillary structure is mainly formed by means of laser processing. The vapor chamber is made of titanium material instead of other material so that the titanium material can be processed by laser to solve the problems that the titanium material is difficult to process and the oxide is produced at high temperature and is uneasy to reduce.

The heat dissipation device of the present invention is not limited to the vapor chamber. Alternatively, the heat dissipation device of the present invention can be a flat-plate heat pipe or other heat dissipation device that employs titanium material as the material of the base seat and needs to be processed to form the capillary structure.

The titanium material is selectively employed to eliminate the shortcomings of the conventional vapor chamber that the other material is employed and is easy to corrode and the structural strength is poor and the vapor chamber is too heavy.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

1. A manufacturing method of a heat dissipation device, comprising steps of:
providing an upper plate and a lower plate and a tubular body;
forming a capillary structure on one face of the lower plate by means of laser processing;
mating the upper and lower plates with each other and correspondingly disposing the tubular body between the upper and lower plates and sealing a periphery of the upper and lower plates together with the tubular body to form a chamber; and
vacuuming the chamber and filling water into the chamber from the tubular body and finally sealing the tubular body.

2. The manufacturing method of the heat dissipation device as claimed in claim 1, wherein the lower plate is made of commercial pure titanium or titanium alloy.

3. The manufacturing method of the heat dissipation device as claimed in claim 1, wherein the upper plate is made of a material selected from a group consisting of gold, silver, copper, aluminum, stainless steel, titanium and ceramic material.

4. The manufacturing method of the heat dissipation device as claimed in claim 1, wherein the capillary structure is a micro-channeled structure or a structure composed of multiple raised bodies or recesses arranged at intervals.
